(19) United States
(12) Patent Application Publication
(10) Pub. No.: US 2007/0189280 A1
(43) Pub. Date: Aug. 16, 2007

(54) Providing information relating to a telephone call

(76) Inventor: Nicholas Ian Hancock, London (GB)

Correspondence Address: NIXON & VANDERHYE, PC, 901 NORTH GLEBE ROAD, 11TH FLOOR, ARLINGTON, VA, 22203, US

(21) Appl. No.: 11/578,834

(22) PCT Filed: Apr. 6, 2005
(86) PCT No.: PCT/GB05/01337

§ 371 Date: Jan. 5, 2007

(30) Foreign Application Priority Data
Apr. 19, 2004 (GB) 0408663.3

(51) Int. Cl. H04L 12/66

(52) U.S. Cl. 370/356

(57) ABSTRACT

A client software application runs on a device, which can itself be used to make phone calls. Based on the phone number of the device, or the phone number of a called party, the client application interacts with a server, which is associated with a telephone gateway. The server sends relevant information to the client application, which can use the information as required, for example by displaying the information to the user. The interaction between the client and the server can take place before or after a call between the device and the called party.

This invention relates to the provision of information, relating to a telephone call. In particular, it concerns the use of a device, to make telephone calls, that also has network connectivity via protocols such as TCP/IP embedded within it.

There exist conventional systems, known as telephone gateways, which accept a call from a user, followed by DMTF dial tones that indicate a final destination number that the user wishes to call. Telecommunications service providers use these systems to offer long-distance or international calls, at rates which are cheaper than those offered by the telephone company operating the direct connection to the user's phone.

U.S. Pat. No. 6,693,893 discloses a system, in which there is a gateway to the PSTN from an IP network, where messages sent to the gateway control an application on the PSTN.

U.S. Pat. No. 6,636,504 describes the use of an intelligent network to provide a reverse billing mechanism for Voice over IP calls.

U.S. Pat. No. 6,614,781 discloses Voice over IP gateways which communicate with an existing PSTN, allowing packet switching of voice calls.

U.S. Pat. No. 6,600,733 discloses a system for creating a gateway between the PSTN and the Internet, that allows establishment of a packet-switched connection and a circuit-switched connection, in response to a call request.

U.S. Pat. No. 6,594,257 and U.S. Pat. No. 6,144,667 disclose a mechanism whereby a web server can send messages to a gateway that will create a call between two telephones connected to the PSTN.

U.S. Pat. No. 6,694,000 discloses using a web browser to access a telephone billing system to determine billing details such as the cost of the last call made. This prior art system has the disadvantage that the phone numbers, of the phone that was used to make the call and the phone that was just called, must both be entered manually by the end user after starting up the web browser, which makes the system inconvenient to use.

According to the present invention, there are provided methods and systems, in which a client application runs on a device, which can itself be used to make phone calls. Based on the phone number of the device, or the phone number of a called party, the client application interacts with a server, which is associated with a telephone gateway. The server sends relevant information to the client application, which can use the information as required, for example by displaying the information to the user. The interaction between the client and the server can take place before or after a call between the device and the called party.

In preferred embodiments of the invention, the client application interacts with the server in response to the selection by the user of a phone number of a party to be called. The server is associated with a PSTN gateway, and returns to the user information relating to the cost of the intended call, if dialed through the associated gateway. The client application presents the returned information to the user, who can then decide whether to initiate the intended call directly, or through the associated gateway.

If the user chooses to initiate the intended call through the associated gateway, this can be done either by calling the gateway from the user device, or by initiating a call from the gateway to the user device.

In preferred embodiments of the invention, the user device has a telephone connection to the gateway, and can make or receive conventional voice calls to or from the gateway. In alternative preferred embodiments of the invention, the user device has an internet connection to the gateway, and can make or receive Voice over IP calls to or from the gateway.

Other aspects of the invention relate to the user terminals which are adapted to operate in such systems, the gateway device which is adapted to operate in such systems, and the software products which run on the user terminals and the gateway device respectively to produce the required functionality.

### BRIEF DESCRIPTION OF DRAWINGS

FIG. 1 is a block schematic diagram of a communication system in accordance with the present invention.

FIG. 2 illustrates the steps taken in the client device and in the server in a method in accordance with the present invention.

FIG. 3 illustrates the steps taken in the client device and in the server in an alternative method in accordance with the present invention.

FIG. 4 is a block schematic diagram of an alternative communication system in accordance with the present invention.

### DETAILED DESCRIPTION OF PREFERRED EMBODIMENTS

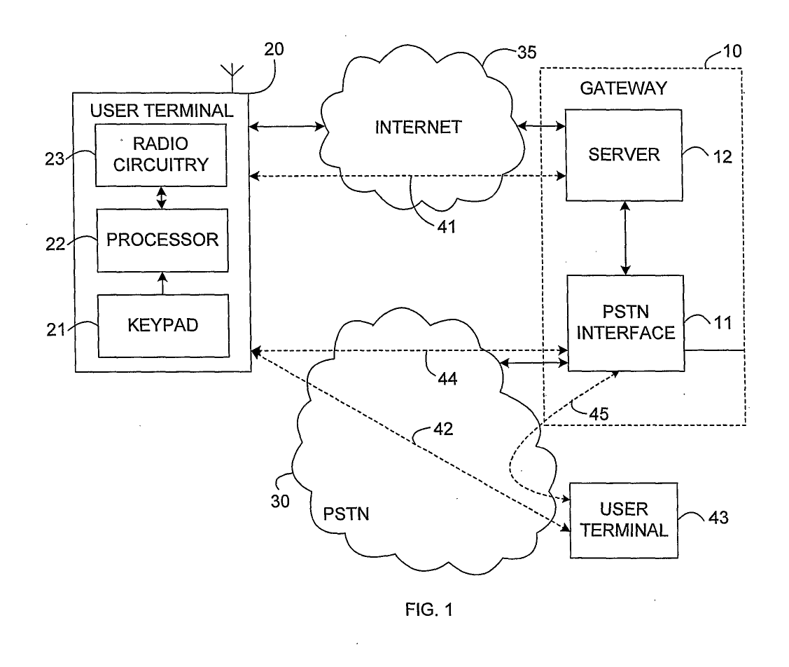

FIG. 1 is a block schematic diagram of a communication system.

The system includes multiple telephone gateways 10, of which only one is shown in FIG. 1. The gateway 10 has an interface 11, that can both accept and initiate telephone calls over the Public Switched Telephone Network (PSTN) 30. As is conventional, the gateway has at least one telephone number. In addition, the gateway 10 includes a computer, in the form of a server 12, which can be connected to other computers via a network IP address.

A user is able to access the functionality of the system from a user terminal 20, which may advantageously take the form of a mobile telephone handset. The form of such devices is well known, and will be described here only to the extent required for an understanding of the present invention. As shown in FIG. 1, the user terminal 20 has a keypad 21, by means of which the user can input data, although other input means can of course be provided. The user terminal 20 operates under the control of a processor 22, which receives input data from the keypad 21. Communications to and from the user terminal 20 are performed by means of radio circuitry 23.

That is, the user terminal 20 is able to establish a connection to the PSTN 30, by means of a mobile communications network, which is not shown here for reasons of clarity. In addition, the user terminal 20 has permanent access over the mobile communications network to the internet 35. In order to provide these connections, the user terminal 20 may be a cellular phone with a GPRS connection, or a so-called “third generation” cellular phone. The user terminal 20 may instead take the form of a normal telephone handset associated with a computing device, such as a personal computer or PDA that is connected to the Internet and which has an IP address. The association in such a case would normally mean that the handset and the computing device were in proximity to each other, and that the computing device could initiate calls on the associated handset through an associated PABX.

The invention is implemented in this illustrated embodiment by means of a client-server software system. That is, specific software runs on the server 12 within the gateway 10, and is able to interact with the PSTN interface 11. The client software runs on the embedded processor 22 of the handset 20.

In the alternative described above, where the user terminal takes the form of a normal telephone handset associated with a computing device, the client software runs on the associated computing device.

The client application has built-in knowledge of the Internet address or name of the server 12 in a gateway 10, in order to be able to access it via TCP/IP over the internet 35. It also has built-in knowledge of the telephone number associated with the PSTN interface 11 of the gateway 10, in order to be able to access it via the mobile communications network and the PSTN 30.

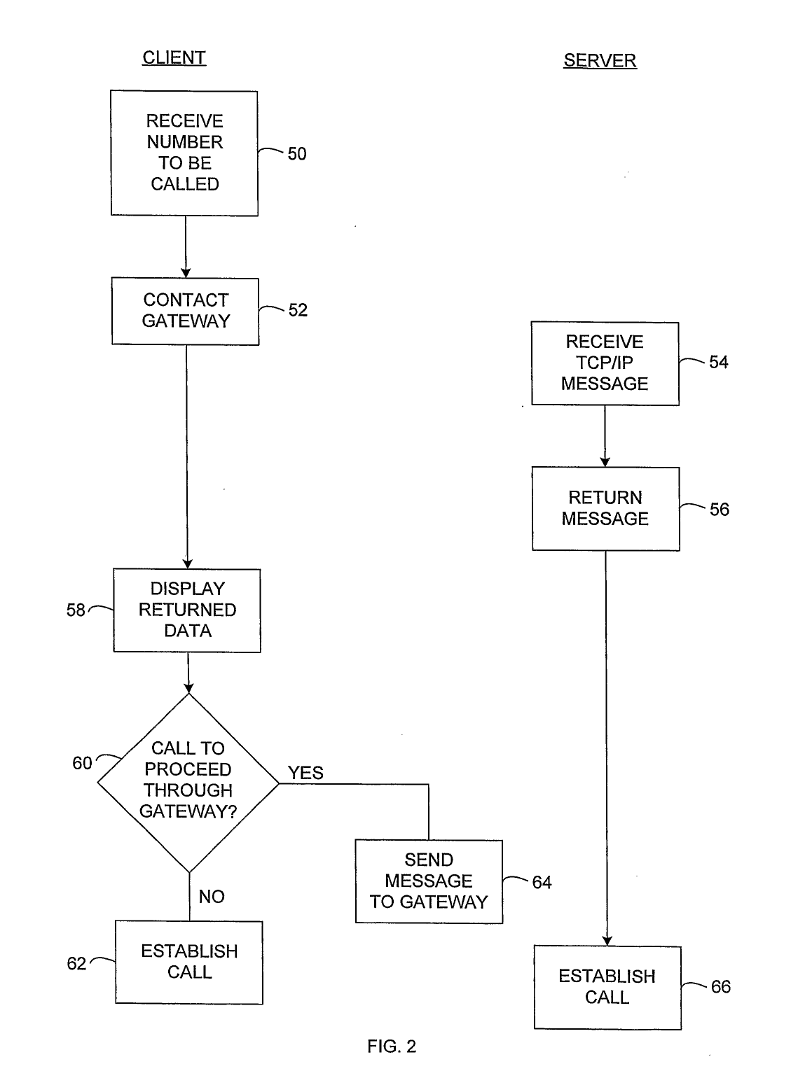

FIG. 2 is a flow chart showing the steps taken in the client application software running on the processor 22, and in the server 12.

In order to make a call, the user enters the number to be called into the processor 22, and this is received by client application in step 50. As is conventional, the number may be entered via the keypad 21, for example by pressing keys representing the digits of the number, or by selecting the number from a phone book function.

In step 52, the client application then establishes an internet connection (illustrated by the dotted line 41 in FIG. 1) with the gateway 10, using its built-in knowledge of the required internet address. The client application then passes over TCP/IP a message which in this example contains as parameters the phone number of the user terminal 20, the number to be called, as entered by the user, and a function code indicating the action to be taken by the server 12.

In step 54, the gateway server 12 receives the TCP/IP message, and the gateway 10 performs processing on the message. In step 56, the gateway server 12 returns an answer to the client application over the internet connection 41.

In step 58, the client application extracts data from the returned message, and displays it to the user. The answer will relate to the calling number, the number to be called or both.

For example, the data might be the time difference between the number being called and the calling number, and the client application may display a message reading “It's 2.30 am where you are about to call. Are you sure you want to continue?” As another example, the data might relate to the cost of a voice call per minute between the two, if dialed through the gateway 10. In that case, the message might read “The call if made through the gateway will cost 4p a minute. Do you wish to use the gateway?” As another alternative, the data might relate to the state of a pre-paid balance associated with the calling device and controlled by the gateway. In that case, the message might read “You have 30p left in your account. Do you wish to use the gateway to continue?”

The action taken by the gateway 10 in generating its returned message will depend on the contents of that message. For example, data relating to the cost of the most recent call can be retrieved directly from the PSTN interface 11, since the server 12 and the PSTN interface 11 are closely linked. Data relating to the expected cost of an intended call can be retrieved from a table in the gateway 10, on the basis of an international or long-distance dialing code forming part of the dialed number.

It will be noted that, in these illustrated cases, the user is presented with a message, giving him the option of proceeding with the call to the entered number via the gateway. However, in other embodiments of the invention, other information may be presented to the user which does not include such a choice.

In step 60, the client application receives the reply entered via the keypad 21 by the user, and determines whether the user has chosen to process the intended call through the gateway 10. If it is determined in step 60 that the user has chosen not to process the intended call through the gateway 10, the process passes to step 62, and the client application can establish the desired connection (illustrated by the dotted line 42 in FIG. 1) by means of the radio circuitry 23 and the associated mobile communications network, and over the PSTN system, with the user terminal 43 which has the called number. It is irrelevant whether the called user terminal 43 is a mobile phone, fixed line phone, or other device.

If it is determined in step 60 that the user has chosen to process the intended call through the gateway 10, the client application establishes the desired connection via the gateway.

Thus, in step 64, the client application can establish the desired connection (illustrated by the dotted line 44 in FIG. 1) by means of the radio circuitry 23 and the associated mobile communications network, and over the PSTN system 30, with the PSTN interface 11 of the gateway 10, using its built-in knowledge of the telephone number associated with the PSTN interface. The message sent by the client application to the PSTN interface 11 includes a sequence of DTMF tones representing the called number of the user terminal 43. Using known techniques, in step 66, the PSTN interface 11 is then able to establish a PSTN connection (illustrated by the dotted line 45 in FIG. 1) with the user terminal 43, and to establish a PSTN connection between the calling user terminal 20 and the called user terminal 43 by bridging the two PSTN connections 44, 45. Again, it is irrelevant whether the called user terminal 43 is a mobile phone, fixed line phone, or other device.

In an alternative embodiment of the invention, the message sent by the client to the gateway in step 64 can contain the calling number and the destination number, and a code that requests a call back from the gateway. In this case, the message sent at step 64 can be sent either over the PSTN 30 to the PSTN interface 11, or over the internet 35 and via the server 12 to the PSTN interface 11. In either case, the gateway responds in step 66 by calling the destination number of the user terminal 43, calling the calling number of the user terminal 20, and connecting, or bridging, the two calls. This alternative is useful when the user terminal is restricted in its ability to make outgoing calls, or where incoming calls are cheaper for the user than outgoing calls.

As described above, the client application sends a message to the gateway 10 in step 52 in response to the user selection of a destination number. In one embodiment of the invention, the messages returned by the advantageously include an indication of the time period for which the returned data may be cached in the user terminal 20. If applicable, the client application then stores the returned data in local memory and, when a further destination number is entered, the client application determines whether it can use the local copy from this cache to fulfil its need for information without needing to send a message to the gateway 10.

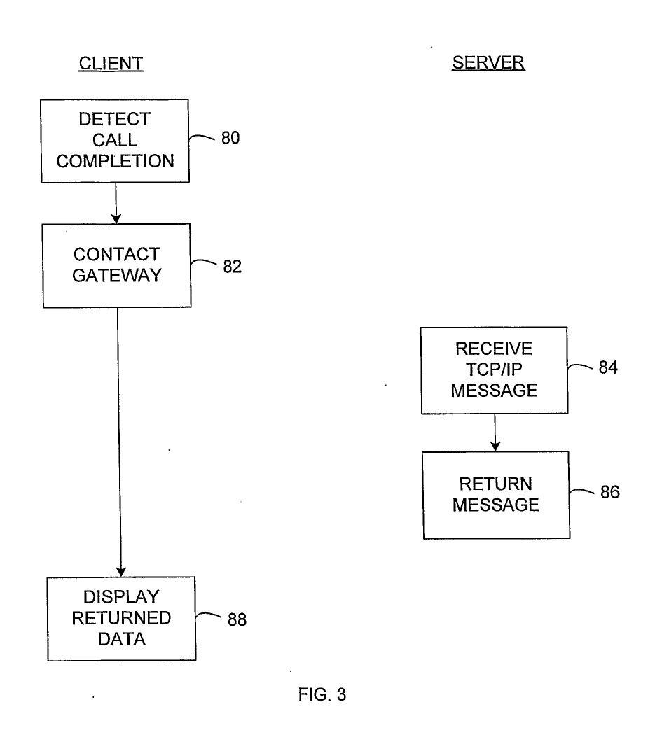

FIG. 3 shows the steps taken as part of a further process in accordance with the invention, which takes place after a call has been completed. The process shown in FIG. 3 can be performed irrespective of how the call was initiated, and thus does not require that the client application should perform any particular steps when receiving a number to be called.

Thus, in step 80, the client application determines that a call has been completed through the gateway 10. In step 82, the client application then establishes an internet connection (illustrated by the dotted line 41 in FIG. 1) with the gateway 10, using its built-in knowledge of the required internet address. The client application then passes over TCP/IP a message which in this example contains as parameters the phone number of the user terminal 20, the number called, as entered by the user, and a function code indicating the action to be taken by the server 12.

In step 84, the gateway server 12 receives the TCP/IP message, and the gateway 10 performs processing on the message. In step 86, the gateway server 12 returns an answer to the client application over the internet connection 41.

In step 88, the client application extracts data from the returned message, and displays it to the user. The answer will relate to the calling number, the number to be called or both. For example, the data may relate to the amount of credit left in the user's account with the gateway service provider, but may also relate specifically to the last call, such as the duration or cost of the call.

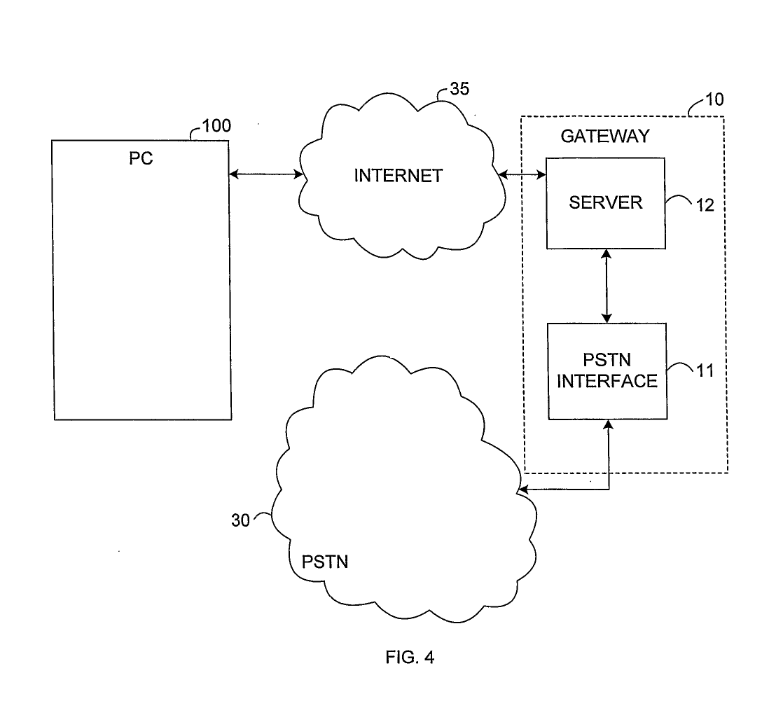

FIG. 4 shows an alternative embodiment of the invention. Features of this embodiment, which are essentially the same as features of the embodiment shown in FIG. 1, are indicated by the same reference numerals. In this embodiment, the user accesses the gateway 10 not via a handset, but by a computing device, which in this illustrated embodiment is a personal computer (PC) 100, but could be any computing device with an internet connection. Thus, the device may have a wired or wireless internet connection, and may have full computing functionality, or may have a limited range of functionality.

The PC 100 runs the client application, which is essentially as described above, and also runs software allowing it to take part in Voice over IP (VoIP) calls. The gateway 10 is also as previously described, but can accept or initiate VoIP calls, as well as being able to connect to the standard PSTN telephone system.

Thus, as shown in FIGS. 2 and 3, the client device can query the gateway before initiating a call via the gateway, although in this case the call is a VoIP call, and then again make further queries when the VoIP call has completed.

There is thus described a system which allows a user of a terminal device to access useful information relating to a call before and/or after the call.

1. A communications system, comprising:
a user terminal, having a user interface, and having an internet connection and a telephone connection which is under software control:
a gateway device, that runs on a computer system with an internet connection and has at least two PSTN connections which are under software control, and which allows those connections to be bridged;
wherein, in response to a destination number input by the user, the user terminal is adapted to establish an internet connection with the gateway device;
wherein the gateway device is adapted to return information to the user terminal over the internet connection; and
wherein the user terminal is able either to:
establish a telephone connection to dial the destination number directly, or
establish a telephone connection to the destination number via the gateway device.

2. A system as claimed in claim 1, wherein the user terminal is adapted to establish a telephone connection to the destination number via the gateway device by dialing the telephone number of a PSTN connection of the gateway device, and to send the destination number to the gateway device as a sequence of DTMF tones, and wherein the gateway is adapted to respond by dialing the destination number and bridging the two calls.

3. A system as claimed in claim 1, wherein the user terminal is adapted to establish a telephone connection to the destination number via the gateway device by sending a further message to the gateway device, and wherein the gateway is adapted to respond to said further message by dialing the destination number and the telephone number of the user terminal, and bridging the two calls.

4. A system as claimed in claim 1 wherein the user terminal is adapted to display on the user interface information obtained from the gateway device and request an input from a user in response to the displayed information; and is further adapted to establish said telephone connection either directly or via the gateway device in response to the requested user input.

5. A system as claimed in claim 1 wherein the user terminal is adapted to store information relating to a user's preferred actions and is further adapted to establish said telephone connection either directly or via the gateway device in response to the stored information.

6. A system as claimed in claim 1 wherein the user terminal is adapted to receive from the gateway device information relating to a user's preferred actions; and is further adapted to establish said telephone connection either directly or via the gateway device in response to the received information.

7. A system as claimed in claim 1, wherein the user terminal is further able, in response to the requested user input, to make no call.

8. A system as claimed in claim 1, wherein the user terminal is further adapted, when a telephone call via said gateway has been completed, to pass further messages to and receive replies from the gateway, such messages including the identity of the user terminal and a function code; and is further adapted to display information obtained from the gateway.

9. A communications system, comprising:
a user terminal, having a user interface, and having an internet connection, and being adapted to make Voice over IP telephone calls;
a gateway device, that runs on a computer system with an internet connection and has at least one PSTN connection under software control, and which allows those connections to be bridged, and being adapted to make Voice over IP telephone calls;
wherein, in response to a destination number input by the user, the user terminal is adapted to establish an internet connection with the gateway device;
wherein the gateway device is adapted to return information to the user terminal over the internet connection; and
wherein the user terminal is able either to:
establish a Voice over IP telephone connection to dial the destination number directly, or
establish a Voice over IP telephone connection to the destination number via the gateway device.

10. A system as claimed in claim 9, wherein the user terminal is adapted to establish a Voice over IP telephone connection to the destination number via the gateway device by establishing a Voice over IP telephone connection to the gateway device, and requesting the gateway device to establish a PSTN connection to the destination number and to bridge the two calls,

11. A system as claimed in claim 9, wherein the user terminal is adapted to establish a Voice over IP telephone connection to the destination number via the gateway device by sending a further message to the gateway device, and wherein the gateway is adapted to respond to said further message by dialing the destination number and by establishing a Voice over IP telephone connection to the user terminal, and by bridging the two calls.

12. A system as claimed in claim 1 wherein the user terminal is adapted to display on the user interface information obtained from the gateway device and request an input from a user in response to the displayed information; and is further adapted to establish said Voice over IP telephone connection either directly or via the gateway device in response to the requested user input.

13. A system as claimed In claim 9 wherein the user terminal is adapted to store information relating to a users preferred actions, and is further adapted to establish said Voice over IP telephone connection either directly or via the gateway device in response to the stored information.

14. A system as claimed in claim 9 wherein the user terminal is adapted to receive from the gateway device information relating to a user's preferred actions; and is further adapted to establish said Voice over IP telephone connection either directly or via the gateway device in response to the received information.

15. A system as claimed in claim 9, wherein the user terminal is further able, in response to the requested user input, to make no call.

16. A system as claimed in claim 9, wherein the user terminal is further adapted, when a telephone call via said gateway has been completed, to pass further messages to and receive replies from the gateway, such messages including the identity of the user terminal and a function code; and is further adapted to display information obtained from the gateway.
